(19) United States
(12) Patent Application Publication
(10) Pub. No.: US 2017/0309194 A1
(43) Pub. Date: Oct. 26, 2017

(54) PERSONALIZED LEARNING BASED ON FUNCTIONAL SUMMARIZATION

(71) Applicant: Hewlett-Packard Development Company, L.P., Houston, TX (US)

(72) Inventors: Steve J. Simske, Fort Collins, CO (US); Marie Vans, Ft. Collins, CO (US); Malgorzata M. Sturgill, Fort Collins, CO (US); Jason S. Aronoff, Fort Collins, CO (US); Georgia Koutrika, Palo Alto, CA (US)

(21) Appl. No.: 15/514,432

(22) PCT Filed: Sep. 25, 2014
(86) PCT No.: PCT/US2014/057417

§ 371 Date: Mar. 24, 2017

(51) Int. Cl. G09B 5/06; G06N 99/00

(52) U.S. Cl. CPC G09B 5/065; G06N 99/005

(57) ABSTRACT

Personalized learning based on functional summarization is disclosed. One example is a system including a content processor, a plurality of summarization engines, at least one meta-algorithmic pattern, an evaluator, and a selector. The content processor provides course material to be learned, the course material selected from a corpus of educational content, and identifies retained material indicative of a portion of the course material retained by user. Each of the plurality of summarization engines provides a differential summary indicative of differences between the course material and the retained material. The at least one meta-algorithmic pattern is applied to at least two differential summaries to provide a meta-summary using the at least two differential summaries. The evaluator determines a value of each differential summary and meta-summary. The selector selects a meta-algorithmic pattern or a summarization engine that provides the meta-summary or differential summary, respectively, having the highest assessed value.

### BACKGROUND

Robust systems may be built by utilizing complementary, often largely independent, machine intelligence approaches, such as functional uses of the output of multiple summarizations and meta-algorithmic patterns for combining these summarizers. Summarizers are computer-based applications that provide a summary of some type of content. Meta-algorithmic patterns are computer-based applications that can be applied to combine two or more summarizers, analysis algorithms, systems, or engines to yield meta-summaries. Functional summarization may be used for evaluative purposes and as a decision criterion for analytics, including delivery of educational content.

### BRIEF DESCRIPTION OF THE DRAWINGS

FIG. 1 is a functional block diagram illustrating one example of a system for personalized learning based on functional summarization.

FIG. 2A is a schematic diagram illustrating one example of an expert feedback pattern.

FIG. 2B is a graph illustrating one example of a feedback gain function.

FIG. 2C is a graph illustrating another example of a feedback gain function.

FIG. 3 is a block diagram illustrating one example of a processing system for implementing the system for personalized learning based on functional summarization.

FIG. 4 is a block diagram illustrating one example of a computer readable medium for personalized learning based on functional summarization.

FIG. 5 is a flow diagram illustrating one example of a method for personalized learning based on functional summarization.

### DETAILED DESCRIPTION

Personalized learning based on functional summarization is disclosed. Education (i.e., learning for knowledge) and training (i.e., learning for proficiency) may differ in their end objectives. For example, education may be directed at not having any “gaps” (e.g., being able to pass a test on a topic) and training may be directed at having a more innate or rote understanding of a topic (e.g., muscle memory associated with memorizing a piece of music). As disclosed herein, multiple summarizers as distinct summarizers or together in combination using meta-algorithmic patterns may be utilized to optimize learning experience based on a learner's personality. Functional summarization involves generating intelligence from educational content and may be used as a decision criterion for analytics related to content delivery.

As described in various examples herein, functional summarization is performed with combinations of summarization engines and/or meta-algorithmic patterns. A summarization engine is a computer-based application that receives a document and provides a summary of the document. The document may be non-textual, in which case appropriate techniques may be utilized to convert the non-textual document into a textual document prior to application of functional summarization. A meta-algorithmic pattern is a computer-based application that can be applied to combine two or more summarizers, analysis algorithms, systems, and/or engines to yield meta-summaries. In one example, multiple meta-algorithmic patterns may be applied to combine multiple summarization engines.

Functional summarization may be applied to personalize a learning environment. For example, course material related to a topic may be provided to a learner, and based on an evaluation of the learner's performance on the course material, reinforcing material, and/or additional course material may be provided. For example, a summary of the learner's performance may be compared to summaries of material available in a corpus of educational content to identify the additional course material that is most similar to the course material, and/or topic that has been learned.

As described herein, meta-algorithmic patterns are themselves pattern-defined combinations of two or more summarization engines, analysis algorithms, systems, or engines; accordingly, they are generally robust to new samples and are able to fine tune personalization of a learning environment to a learner's ability, goal, and/or needs.

As described in various examples herein, personalized learning based on functional summarization is disclosed. One example is a system including a content processor, a plurality of summarization engines, at least one meta-algorithmic pattern, an evaluator, and a selector. The content processor provides, to a computing device via a graphical user interface, course material to be learned by a user, the course material selected from a corpus of educational content, and identifies retained material indicative of a portion of the course material retained by the user. Each of the plurality of summarization engines provides a differential summary indicative of differences between the course material and, the retained material. The at least one meta-algorithmic pattern is applied to at least two differential summaries to provide a meta-summary using the at least two differential summaries. The evaluator determines a value of each differential summary and meta-summary. The selector selects a meta-algorithmic pattern or a summarization engine that provides the meta-summary or differential summary, respectively, having the highest assessed value.

In the following detailed description, reference is made to the accompanying drawings which form a part hereof, and in which is shown by way of illustration specific examples in which the disclosure may be practiced. It is to be understood that other examples may be utilized, and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

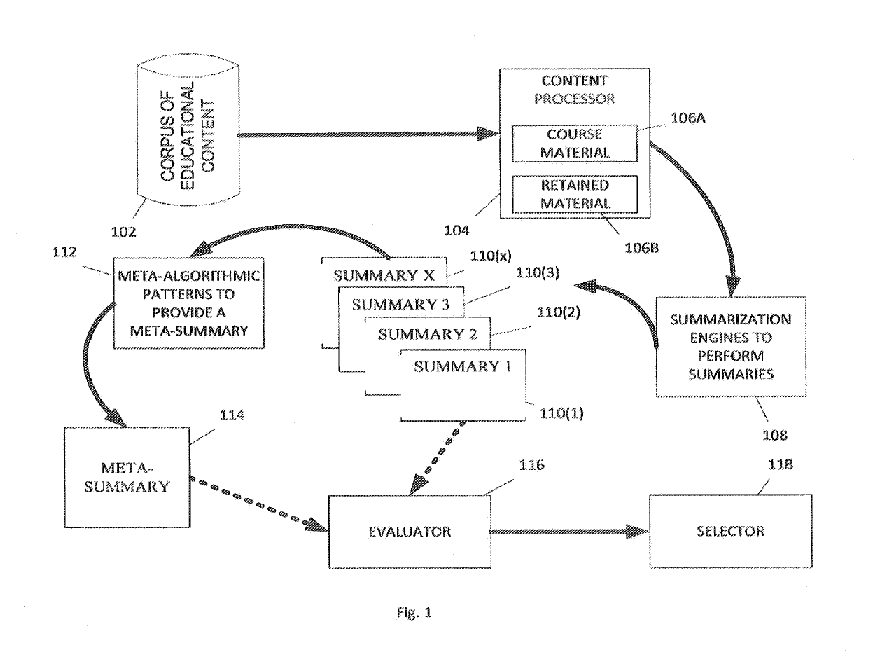

FIG. 1 is a functional block diagram illustrating one example of a system 100 for personalized learning based on functional summarization. The system 100 provides, to a computing device via a graphical user interface, course material to be learned by a user, the course material selected from a corpus of educational content, and identifies retained material indicative of a portion of the course material retained by the user. System 100 applies a plurality of summarization engines, each summarization engine to provide a differential summary indicative of differences between the course material and the retained material. The summaries may be further processed by at least one meta-algorithmic pattern to be applied to at least two differential summaries to provide a meta-summary using the at least two differential summaries. System 100 determines a value of each differential summary and meta-summary, and selects a meta-algorithmic pattern or a summarization engine that provides the meta-summary or differential summary, respectively, having the highest assessed value. 10016j Meta-summaries are summarizations created by the intelligent combination of two or more standard or primary summaries. The intelligent combination of multiple intelligent algorithms, systems, or engines is termed “meta-algorithmics”, and first-order, second-order, and third-order patterns for meta-algorithmics may be defined.

System 100 accesses a corpus of educational content 102 and course material 106A, and identifies retained material 106B. System 100 includes a content processor 104, summarization engines 108, summaries 110(1)-110(x), at least one meta-algorithmic pattern 112, a meta-summary 114, an evaluator 116, and a selector 118, where “x” is any suitable numbers of summaries.

The corpus of educational content 102 may include textual and/or non-textual content. Generally, the corpus of educational content 102 may include any material that a learner may want to learn. In one example, the corpus of educational content 102 may include material related to a subject such as History, Geography, Mathematics, Literature, Physics, Art, and so forth. In one example, a subject may further include a plurality of topics. For example, History may include a plurality of topics such as Ancient Civilizations, Medieval England, World War II, and so forth. Also, for example, Physics may include a plurality of topics such as Semiconductors, Nuclear Physics, Optics, and so forth. Generally, the plurality of topics may also be sub-topics of the topics listed. In one example, the plurality of topics may be separate chapters in a book.

Non-textual content may include an image, audio and/or video content. Video content may include one video, portions of a video, a plurality of videos, and so forth. In one example, the non-textual content may be converted to provide a plurality of tokens suitable for processing by summarization engines 108.

The content processor 104 provides, to a computing device via a graphical user interface, course material 106A to be learned by a user, the course material 106A accessed from the corpus of educational content 102. For example, a user may want to learn about Ancient Civilizations. The content processor 104 may retrieve related content from the corpus of educational content 102. In one example, the content processor 104 may provide a list of learning material, and provide the user an option to select the course material 106A. For example, the content processor 104 may provide a list of books related to Ancient Civilizations, and receive a selection of a book from the list of books. Accordingly, material from the selected book may be provided as course material 106A. Also, for example, the content processor 104 may identify salient subject material related to Ancient Civilizations, and provide a subset of the salient subject material as initial course material 106A. In one example, supplemental material from the salient subject material may be provided later, based at least in part on the summarization techniques disclosed herein.

In one example, the corpus of educational content 102 may include a collection of topics, T₁, . . . , T_{N}. The collection of topics may be represented as a topic vector T. Salient subject material may be represented by a vector M, and for each of the topics T₁, . . . , T_{N}, the salient subject material may be given by:

M={M(T₁),M(T₂), . . . ,M(T_{N})}.

The content processor 104 may provide initial course material 106A for each topic, C, the initial course material 106A denoted by a vector:

C={C(T₁),C(T₂), . . . ,C(T_{N})}.

The material of the salient subject material that is not included in the initial course material 106A may be identified as reserve material, R, and may be denoted by a vector:

{R(T₁),R(T₂), . . . ,R(T_{N})}

### Thus, M(T)=C(T)+R(T):

{M(T₁),M(T₂), . . . ,M(T_{N})}={C(T₁)+R(T₁),C(T₂)+R(T₂), . . . ,C(T_{N})+R(T_{N})}

As described herein, C(T) and R(T) are functions of the topics T. In this way, the system is flexible, and in each iteration C and T may progressively shift to different topics, as needed and/or desired. For example, in the first iteration with the user, C may cover only T₁, while in the second iteration, it may cover T and T₂.

In one example, the course material 106A may be aggregated and there may be no segmentation by topic. In this example, salient subject material M may be a scalar, the course material 106A may be a scalar C, and the reserve material may be a scalar R. As before, M=C+R. Also, there may be a single grade g.

Summarization engines 108 summarize the course material 106A and the retained material 106B to provide a plurality of summaries 110(1)-110(x). In one example, summarization engines 108 provide differential summaries indicative of differences between the retained material 106B and the corpus of educational content 102. Generally, the differential summary is indicative of differences between the material to be learned and the material retained. In one example, differential summary is indicative of differences between the material retained and any additional material that may be provided. In one example, differential summary is indicative of differences between the retained material 106B and course material 106A.

In one example, the differential summary may be based on differences between the course material 106A and the reserve material. In one example, the differential summary may be based on differences between the retained material 106B and the reserve material. Also, for example, the differential summary may be based on differences between the course material 106A and the salient subject material. As another example, the differential summary may be based on differences between the reserve material 106B and the salient subject material.

The differential summaries may include at least one of the following summarization outputs:
(1) a set of key words;
(2) a set of key phrases;
(3) a set of key images;
(4) a set of key audio;
(5) an extractive set of clauses;
(6) an extractive set of sentences;
(7) an extractive set of video dips
(8) an extractive set of clustered sentences, paragraphs, and other text chunks;
(9) an abstractive, or semantic, summarization.

In other examples, a summarization engine may provide a summary including another suitable summarization output. Different statistical language processing (“SLP”) and natural language processing (“NLP”) techniques may be used to generate the summaries. For example, a textual transcript of a video may be utilized to provide a summary. In one example, portions of the video may be extracted based on the summary.

System 100 includes at least one meta-algorithmic pattern 112 used to summarize summaries 110(1)-110(x) to provide a meta-summary 114. Each meta-algorithmic pattern is applied to at least two differential summaries to provide a meta-summary using the at least two differential summaries. In one example, the at least one meta-algorithmic pattern is based on one or more of the following approaches, as described herein:
(1) Expert Feedback;
(2) Sequential Try;
(3) Sensitivity Analysis; and
(4) Proof by Task Completion.
   In other examples, a meta-algorithmic pattern may be based on another suitable approach. The four meta-algorithmic patterns enumerated herein are described in more detail.

System 100 includes an evaluator to determine a value of each differential summary and meta-summary. Evaluator 116 determines a value or relevance of each summary 110(1)-110(x) and each meta-summary 114. Each 110(1)-110(x) and meta-summary 114 may be evaluated for its relative value in the task of providing personalized learning material. The relative value, (i.e., the relevance or utility for providing personalized learning material), may be evaluated based on a ground truth set, and the feedback received from a learner, or other suitable criteria.

Selector 118 selects the summary or meta-summary based on the assessed value, (or utility or relevance), to the task of providing personalized learning material to provide recommended deployment settings. In one example, selector 118 selects the summary or meta-summary having the highest assessed value to the task of providing personalized learning material to provide recommended deployment settings. In other examples, selector 118 selects the summary or meta-summary having an assessed value over a predefined threshold for the task of providing personalized learning material to provide recommended deployment settings. The recommended deployments settings include the summarization engines and/or meta-algorithmic patterns that provide the optimum summarization architecture for the task of providing personalized learning material. The optimum summarization architecture can be integrated into a system real-time. The system can be re-configured per preference, schedule, need, or upon the completion of a significant amount of new instances of tasks of providing personalized learning material.

Education is learning tied to proof of understanding. As disclosed herein, educational materials are delivered to users followed by grading the proficiency of the users (e.g., by using tests, quizzes, or other means of assessing material familiarity/confluence). For the education task, the summaries and meta-summaries are evaluated to determine the summarization architecture that provides the educational materials that result in the highest absolute and/or relative scores. The summarization architecture is then selected and recommended for deployment.

Closely related to education, is educational training. Training is learning tied to measurable proof of ability. Training materials are delivered to users followed by scoring of the capability of the users (e.g., by the ability to perform a task). For the training task, the summaries and meta-summaries are evaluated to determine the summarization architecture that provides the training materials that result in the highest absolute and/or relative scores. The summarization architecture is then selected and recommended for deployment.

Text chunking/segmentation is a method of summarizing or presenting text that splits concepts into small pieces of information to make reading and understanding more efficacious. Chunking includes bulleted lists, short subheadings, condensed sentences with one or two ideas per sentence, condensed paragraphs, scan-friendly text (e.g., with key words and concepts italicized or boldfaced), and graphics designed to guide the eyes to key sections. For the text chunking/segmentation task, the summaries and meta-summaries are evaluated to determine the summarization architecture that results in better understanding of the course material and/or training material, or results in better matching to an expert-provided chunking/segmentation (e.g., a blurb). The summarization architecture is then selected and recommended for deployment.

In one example, a vector space model (“VSM”) may be utilized to compute the values, and in this case the similarities of a summarization vector based on a differential summary, and reinforcement vectors based on the corpus of educational content. In one example, the reinforcement vectors may be based on the salient subject matter, and/or topics from a collection of topics that remain to be learned.

The vector space itself is an N-dimensional space in which the occurrences of each of N terms (e.g. terms in a query, substrings of a binary string) are the values plotted along each axis for each of D tokenized content. The vector \vec{d} may be a differential summarization vector based on tokens extracted from a differential summary, while the vector \vec{c} is a reinforcement vector. The dot product of \vec{d} and \vec{c}, or \vec{d}·\vec{c}, is given by:

$$\vec{d} \cdot \vec{c} = {\sum }_{w = 1}^{N} {d}_{w} {c}_{w} \qquad ( Eq . 1 )$$

In one example, the similarity value between a reinforcement vector and the differential summarization vector may be determined based on the cosine between the reinforcement vector and the differential summarization vector:

$$cos ( \vec{d} , \vec{c} ) = \frac{\vec{d} \cdot \vec{c}}{\vert \vec{d} \vert \vert \vec{c} \vert} = \frac{{\sum }_{w = 1}^{N} {d}_{w} {c}_{w}}{\sqrt{{\sum }_{w = 1}^{N} {d}_{w}^{2}} \sqrt{{\sum }_{w = 1}^{N} {c}_{w}^{2}}} \qquad ( Eq . 2 )$$

The selector 118 may select for deployment the meta-algorithmic patterns and/or the summarization engines which provide the meta-summaries and/or differential summaries, respectively, having the highest assessed similarity values. In one example, the content processor 104 further identifies, based on the deployed meta-algorithmic patterns and/or the summarization engines, potential material to be provided to the user, the potential material selected from the corpus of educational content 102. In one example, the content processor 104 personalizes the potential material to the user, as described for each of the meta-algorithmic algorithms described herein. In one example, the content processor 104 personalizes the potential material to identify reinforcement material of the course material 106A.

In one example, the course material 106A includes a collection of topics from the corpus of educational content 102, and the content processor 104 personalizes the potential material to generate a sequence of topics based on the collection of topics. For example, similarity values between differential summarization vectors and reinforcement vectors based on the collection of topics may be determined. A topic of the collection of topics may be selected based on the similarity values. For example, a topic that is most similar to the retained material 106B may be identified and provided to the user.

In one example, the topics in the collection of topics may be ranked based on respective similarity values to generate a sequence of topics based on the collection of topics. Such a sequence may be iteratively provided to the user. For example, after a first topic is mastered by the user, a next topic from the generated sequence of topics may be provided. In one example, a continuous feedback process may update values for the summaries and/or meta-summaries, and the sequence may be dynamically changed and adapted to a learner's needs and/or learning abilities.

In one example, T₁, T₂, T₃ may be three topics to be learned, and M may denote the available material for these topics. The material may be provided to the user based on performance. Among several possible strategies, one may be to expose the learner to material for topic T₁ first. If the learner performs well and does not need to see any more T₁ material for proficiency, then the content processor 104 has an option of providing material for just T₂, for just T₃, or both. If the learner performs reasonably on T₁, content processor 104 may provide some additional T₁ material. In one example, some material from T₂ may also be provided. Content processor 104 may determine the material to be provided, based for example, on the similarity values for topics T₁, T₂, T₃ and the retained material on T₁. Providing the most similar topic after achieving proficiency in a given topic is a form of sensitivity analysis actionability.

Such an approach may be employed for each of the meta-algorithmic algorithms described herein in addition to each of the individual summarizers.

In one example, the at least one meta-algorithmic pattern 112 includes an expert feedback pattern. The Expert Feedback pattern is used to feed back a portion of an output (in this case, performance on the material to be learned) to an input (in this case, the course material 106A—either primary or supplementary—to be learned). The manner in which learning is augmented may be governed by a feedback gain function, whereas a relative amount of supplementary material may be governed by a forward gain function.

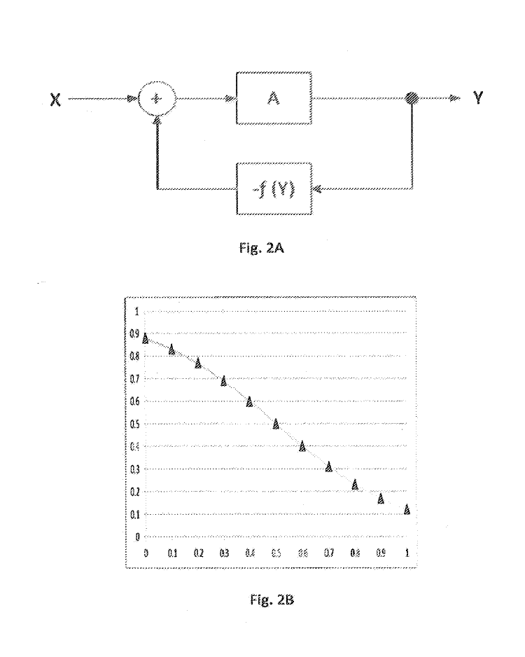

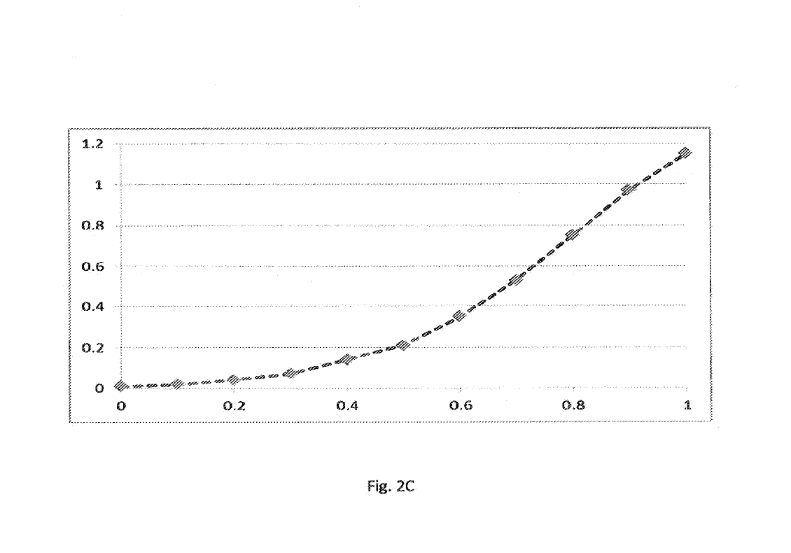

FIG. 2A is a schematic diagram illustrating one example of an expert feedback pattern. The Expert Feedback pattern uses a control loop where output feedback is fed to the input to allow comparison of input to a gain element. For example, course material 106A (from FIG. 1) may be denoted by input X. The retained material 106B (from FIG. 1) may be denoted by output Y. A forward gain, A, and a feedback gain, −f(Y), are also illustrated. In one example, instead of adding the negative f(Y) to the input as −f(Y), a positive f(Y) may be subtracted from the input. A functional relation between the course material and the retained material may be determined. In one example, the output Y relates to the input. X, according to the following:

Y=A[X−f(Y)Y]

Y=AX−Af(Y)Y

Y[1+Af(Y)]=AX

Accordingly, the functional relation between the course material and the retained material may be determined as:

$$Y = [ \frac{A}{1 + Af ( Y )} ] X$$

A transfer function may be obtained as:

$$Y \text{/} X = [ \frac{A}{1 + Af ( Y )} ]$$

The gain of the system is a function of f(Y), and is given by

$$\frac{A}{1 + A \vert \vert f ( Y ) \vert \vert} ,$$

where ∥f(Y)| is the magnitude of the feedback gain −f(Y). Generally, f(Y) may not be a constant. For example, in a broad salient subject material, the feedback may be inversely proportional to a person's understanding of the subject material. For example, in Biology, a typical course material 106A may include 100 chapters. Also, for example, in Literature, a typical course material 106A may include 10-15 long reading assignments. Accordingly, for a given topic, the topics for which the user has the best understanding may be presumably the topics requiring the least reinforcement in the future. Such a reinforcement strategy may be converted into the feedback gain function f(Y) plotted against Y, the user's current proficiency in an area.

FIG. 2B is a graph illustrating one example of a feedback gain function. The example feedback gain function f(Y) is plotted against Y. Y in the curve illustrated here is a measure of the proficiency of the person in the given subject of knowledge. In this example, the curve takes the form of a Sigmoid. For the graph illustrated herein, f(Y) is the ordinate axis and Y is the abscissa, the following relationship is given for the feedback gain, G_{F}=f(Y):

$${G}_{F} = f ( Y ) = \frac{G}{1 + {e}^{{G}_{S} ( Y - μ )}}$$

where Gs is a Sigmoid Gain, which controls the relative slope of the curve, and G_{S}=4.0 for the curve illustrated herein. The value G is the overall gain, which determines a maximum rate of reinforcement of material, and in the equation above, G is set to 1.0. Accordingly, if a user fails to demonstrate understanding of course material 106A (in FIG. 1), then the user is sent the same amount of course material to re-learn. The value p is the mean or pivot value for the Sigmoid curve, and μ=0.5 in the curve illustrated herein, representing a centered distribution. This equation allows multiple mechanisms for personalization, to be described herein. The feedback as described herein captures personalized reinforcement of the material.

In one example, G, the overall gain, may determine the maximum amount of reinforcement (e.g., reserve) material to deliver for learning purposes. Since the value of e^{G}^{_{S}}^{(Y-μ)} is confined to the range (0,+∞), this means that max(G_{F})=G. For the given values in the example—where G=1, G_{S}=4.0 and μ=0.5—this value of G may not be attainable. In fact, if the learner were to get a grade of 0.0 (corresponding to no learning, e.g., retained material 106B is zero), the value of

$${G}_{F} = f ( Y ) = \frac{G}{1 + {e}^{{G}_{S} ( Y - μ )}} = \frac{1.0}{1 + {e}^{- 2.0}} = 0.88 .$$

This means that a learner who learned nothing will receive ⅞^{th} (88%) as much reserve material as they received of original course material 106A. Of the three settings. G, G_{S}, and μ, G is the typically most sensitive to the learner. G may be tuned to have any reasonable value; for example, a grade of 0.0 means a new set of material equal in size to the original material will be sent (here, G=1.14).

In one example, G_{S}, the Sigmoid gain, may determine the slope of the curve and is most sensitive (i.e. has the highest slope) immediately to each side of the pivot, or mean μ. The value of G_{S} may be topic sensitive in addition to being learner-sensitive. For example, certain topics, which may be more diffuse in knowledge (e.g., History), may benefit from a gentler slope (e.g., a lower value of G_{S}), and whereas a more technical topic (e.g., Thermodynamics) may requires a higher slope. This may be because below a certain level of proficiency, significant incremental reinforcement (e.g. through additional problem sets) may be required. In such a case, more than one function may be determined: a first function per topic together with a second function that combines the respective learning outputs. Accordingly, there may be constraints on how much material may be returned to a learner at any given point or time constraints as discussed herein.

In one example, the pivot value, or mean p, may determine the relative proficiency a learner must have before moving on to another topic. A value of 0.7, for example, may correspond roughly to 70% being a “passing grade”. A value of 0.9 may mean that a higher proficiency may be required. For example, in a mission-critical learning situation (i.e. picking up a skill required for safety), a higher proficiency may be necessary before additional material may be provided. The value of Gs, if high enough, may prevent a learner from moving on before reaching a required proficiency.

In one example, the course material 106A may be graded resulting in the following set of grades g:

{g(T₁),g(T₂), . . . ,g(T_{N})}

The set of grades g may be utilized to determine a delivery of the reserve material, R. In one example, the content processor 104 may identify retained material 106B indicative of a portion of the course material retained by the user. In one example, the content processor 104 may identify retained material 106B based on the set of grades g. In one example, the course material 106A may be aggregated and there may be no segmentation by topic. Accordingly, there may be a single grade g.

Each g(T₁) may be utilized as Y in the curve illustrated in FIG. 2B, and so:

$${G}_{F} ( {T}_{i} ) = f ( g ( {T}_{i} ) ) = \frac{G}{1 + {e}^{{G}_{S} ( g ( {T}_{i} ) - μ )}}$$

The learner may be provided the set of GF(Ti) for all i=1, . . . , N topics. In this case, each of the topics is managed independently. The amount of additional learning material that is provided for reinforcement is GF(Ti), which is a function of the grade g(i).

In this example, it is assumed that the output (and through the feedback function it becomes again part of the input) Y is the measured success in learning, and the general assumption is that f(Y) will be inversely proportional to Y during learning; that is, that reinforcement will focus on topics where the learner is weak.

In one example, a different approach may be required for two different types of learning. The learning of true mastery, and separately sequentially focused in-depth learning often associated with, for example, research, and may require the skill Y to be made directly proportional to f(Y).

If such in-depth proficiency is desired, the approach above may be used. However, the relationship for the feedback gain, GF=f(Y), will take on a different curve. It may still be a Sigmoid curve, but will monotonically increase rather than monotonically decrease across the Y range of [0,1].

FIG. 2C is a graph illustrating another example of a feedback gain function. In this example, the feedback gain function f(Y) plotted against Y is tailored for a “mastery” of proficiency learning application. As an example, the feedback function f(Y) may be as follows:

$${G}_{F} = f ( Y ) = \frac{1.5}{1 + {e}^{- 6 ( Y - 0.8 )}} = \frac{1.5}{1 + {e}^{4.8 - 6 Y}}$$

where in this example G_{S}=−6, G=1.5 and μ=0.8. Since G is greater than 1.0, the amount of reinforcement/reserve material, R, exceeds the previous amount delivered, C, wherever G_{F} is greater than 1.0. In the graph illustrated herein, this occurs for a proficiency score above 0.9155, and peaks at R=1.153 C when the learner learns 100% of the original content. In other words, a highly proficient student is rewarded for proficiency with an ever-increasing amount of new material. This process may be continued iteratively until the reserve content R is exhausted, and/or a measurable learning objective is achieved.

As described herein, in one example, the content processor 104 may personalize the potential material based on a functional relation between the course material 106A and the retained material 106B (as evaluated by the grades g). In one example, the feedback function, such as the Sigmoid functions described herein, may be utilized to support multiple types of personalized learning. Differential summarization is usable for assessing the value of Y. The individual assignments may be graded with a numerical score of [0, 1.0], and these scores used as weightings for the atomic components (words, etc.) of each assignment. These weightings may be used to direct the final weightings of the summarization (or key word extraction) engines. The extraction summary obtained for the output may then be compared (subtracted from) the summary obtained for the reserve material. Content in reserve that is not in the summary of successful learning will then be preferentially delivered. Various machine learning and dynamic programming techniques may be used to determine personalized values of, for example, the settings for the feedback parameters (G, G_{S}, μ).

In one example, the content processor 104 may personalize the potential material to optimize the best learning experience from the learner's perspective. There may be some related parameters that could be possibly involved. In one example, the content processor 104 may personalize the potential material to minimize learning time. If minimizing learning time is important, then the problem may be an optimization problem for reinforcement learning, where the purpose may be to cover the course material 106A as best as possible in the given time period. A plurality of constraints may be used to describe different forms of the problem. For example, one objective may be to cover most of the material in the given time, or to cover at least ⅔ of the material with performance above a predetermined threshold in performance in a given time period, etc. Based on time, content processor 104 may identify the potential material, and the speed at which the potential material is provided. Also, for example, content processor 104 may determine which topic of a sequence of topics to move to. For example, different topics may be associated with different learning times, and the content processor 104 may determine a next topic based on the associated time. In one example, content processor 104 may balance competing constraints of time taken and level of difficulty to determine the potential material. In one example, the content processor 104 may personalize the potential material based on resource allocation per iteration. For example, the content processor 104 may identify how much material may be provided at each increment. This factor may affect cost, licensing, etc. In one example, content processor 104 may balance competing constraints of time taken, amount of material, and level of difficulty to determine the potential material.

In one example, the at least one meta-algorithmic pattern 112 includes a Sequential Try pattern to identify potential material until one potential material is selected with a given confidence relative to the other potential materials. If no potential material is obvious after the sequential set of tries is exhausted, the next pattern may be selected. This pattern comprises trying one algorithm after another until success is achieved. As such, the Sequential Try pattern for learning comprises reinforcement to help master related content. A strategy in the sequence may be, for example, a different tetrad of (A, G, G_{S}, μ). Strategies may be ordered based on predicted a priori accuracy, and attempted one after the other until proficiency is achieved. As with expert feedback, proficiency may be determined through successful completion of a test question, task, set of questions, set of tasks, and so forth. As described herein, differential summarization may be utilized to determine which of the reinforcing/reserve to deliver.

In one example, the at least one meta-algorithmic pattern 112 includes sensitivity analysis. Sensitivity Analysis is a broad meta-algorithmic pattern that looks for correlation or reduced entropy situations that are generally indicative, in learning, of related material that may reinforce learning in more than one area. Sensitivity Analysis may be used to assess which content to provide as reserve/reinforcement content, as described herein. The reinforcement content with the highest dot product (sum of multiplied weights) with the differential summarization is next in the queue for delivery.

In one example, the at least one meta-algorithmic pattern 112 includes proof by task completion. Proof by Task Completion is related to Sequential Try inasmuch as the successful completion of a test question, task, etc., is used to train the system. However, for this pattern, the successes in learning may be used to automatically train the settings of the personalized learning ecosystem; e.g. the tetrad of (A, G, G_{S}, p). As described herein, differential summarization may be utilized to determine which of the reinforcing/reserve to deliver.

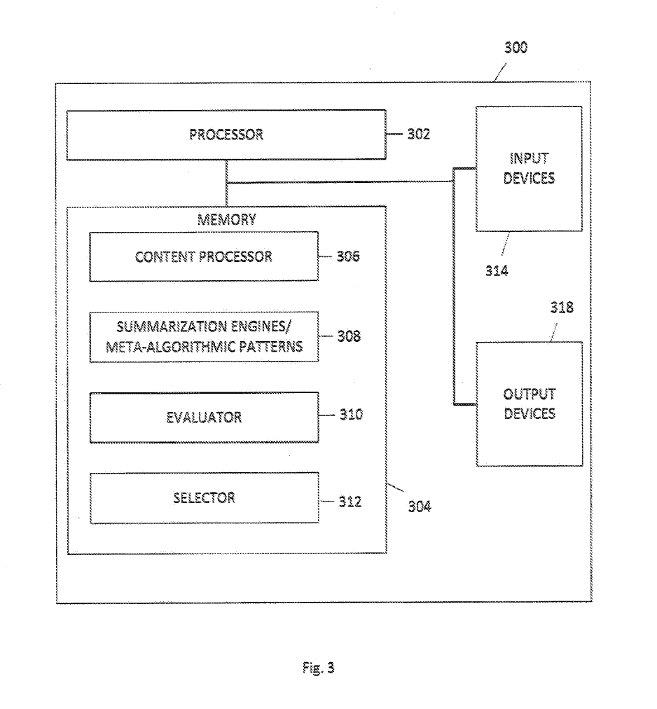

FIG. 3 is a block diagram illustrating one example of a processing system 300 for implementing the system 100 for personalized learning based on functional summarization. Processing system 300 includes a processor 302, a memory 304, input devices 314, and output devices 318. Processor 302, memory 304, input devices 314, and output devices 318 are coupled to each other through communication link (e.g., a bus).

Processor 302 includes a Central Processing Unit (CPU) or another suitable processor. In one example, memory 304 stores machine readable instructions executed by processor 302 for operating processing system 300. Memory 304 includes any suitable combination of volatile and/or non-volatile memory, such as combinations of Random Access Memory (RAM), Read-Only Memory (ROM), flash memory, and/or other suitable memory.

Memory 304 stores instructions to be executed by processor 302 including instructions for a content processor 306, summarization engines and/or meta-algorithmic patterns 308, an evaluator 310, and a selector 312. In one example, memory 304 also stores the differential summarization vector and reinforcement vectors. In one example, content processor 306, summarization engines and/or meta-algorithmic patterns 308, evaluator 310, and selector 312, include content processor 104, summarization engines 108, and/or meta-algorithmic patterns 112, evaluator 116, and selector 118, respectively, as previously described and illustrated with reference to FIG. 1.

In one example, processor 302 executes instructions of content processor 306 to provide, to a computing device via a graphical user interface, course material to be learned by a user, the course material selected from a corpus of educational content. Processor 302 executes instructions of content processor 306 identify retained material indicative of a portion of the course material retained by the user. Processor 302 executes instructions of a plurality of summarization engines and/or meta-algorithmic patterns 308 to provide a differential summary indicative of differences between the retained material and the corpus of educational content, and to provide a meta-summary using at least two differential summaries. Processor 302 executes instructions of an evaluator 310 to determine a value of each differential summary and meta-summary. In one example, the values may be based on the cosine similarity between a differential summarization vector and reinforcement vectors. Processor 302 executes instructions of a selector 312 to select a meta-algorithmic pattern or a summarization engine that provides the meta-summary or differential summary, respectively, having the highest assessed value. In one example, processor 302 executes instructions of a selector 312 to select for deployment the meta-algorithmic patterns and/or the summarization engines which provide the mete-summaries and/or differential summaries, respectively, having the highest assessed values.

In one example, processor 302 executes instructions of a content processor 306 to identify, based on the deployed meta-algorithmic patterns and/or the summarization engines, potential material to be provided to the user, the potential material selected from the corpus of educational content. In one example, processor 302 executes instructions of a content processor 306 to personalize the potential material to the user. In one example, processor 302 executes instructions of a content processor 306 to personalize the potential material to minimize learning time. In one example, processor 302 executes instructions of a content processor 306 to personalize the potential material to generate a sequence of topics based on the collection of topics. In one example, processor 302 executes instructions of a content processor 306 to identify reinforcement material of the course material.

Input devices 314 include a keyboard, mouse, data ports, and/or other suitable devices for inputting information into processing system 300. In one example, input devices 314 are used to input feedback from users for evaluating the course material. Output devices 318 include a monitor, speakers, data ports, and/or other suitable devices for outputting information from processing system 300. In one example, output devices 318 are used to output reinforcement material to users.

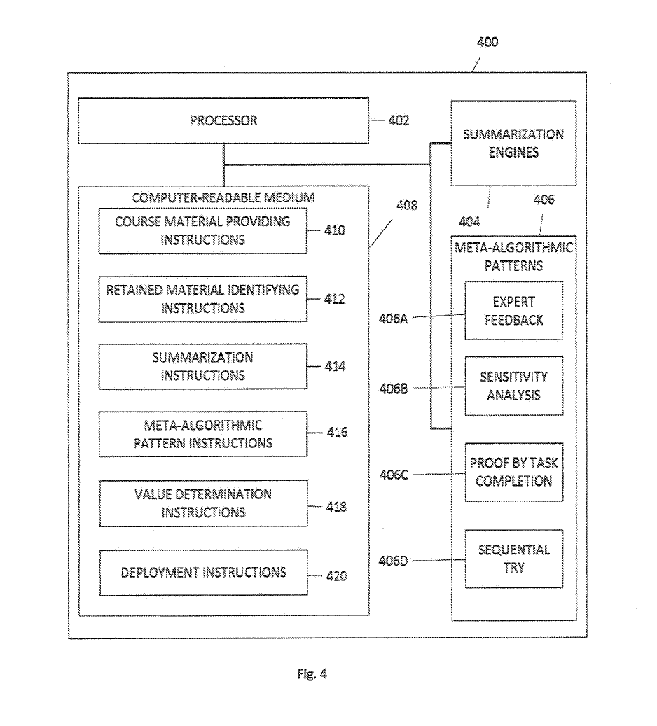

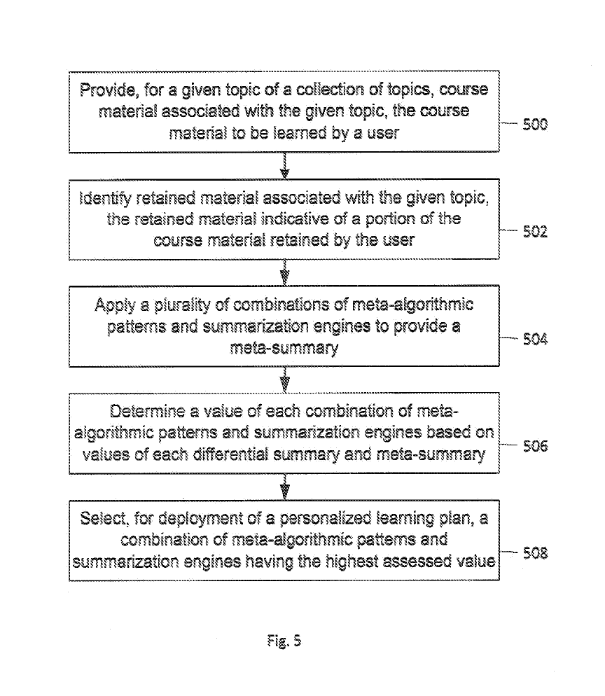

FIG. 4 is a block diagram illustrating one example of a computer readable medium for personalized learning based on functional summarization. Processing system 400 includes a processor 402, a computer readable medium 408, a plurality of summarization engines 404, and at least one meta-algorithmic pattern 406. In one example, the at least one meta-algorithmic pattern 406 includes the Expert Feedback 406A, Sensitivity Analysis 406B, Proof by Completion 406C, and Sequential Try 406D. Processor 402, computer readable medium 408, the plurality of summarization engines 404, and the at least one meta-algorithmic pattern 406 are coupled to each other through communication link (e.g., a bus).

Processor 402 executes instructions included in the computer readable medium 408. Computer readable medium 408 includes course material providing instructions 410 to provide, to a computing device via a graphical user interface, course material to be learned by a user, the course material selected from a corpus of educational content. Computer readable medium 408 includes retained material identifying instructions 412 to identify retained material indicative of a portion of the course material retained by the user. Computer readable medium 408 includes summarization instructions 414 of a plurality of summarization engines 404 to provide a differential summary indicative of differences between the retained material and the corpus of educational content. Computer readable medium 408 includes meta-algorithmic pattern instructions 416 of at least one meta-algorithmic pattern 406 to provide a meta-summary using at least two differential summaries. Computer readable medium 408 includes value determination instructions 418 to determine a value of each differential summary and meta-summary. In one example, computer readable medium 408 includes deployment instructions 420 to deploy, to provide a personalized learning plan to the user, the meta-algorithmic patterns and/or the summarization engines which provide the meta-summaries and/or differential summaries, respectively, having the highest assessed values. In one example, computer readable medium 408 includes deployment instructions 420 to determine, based on the deployed meta-algorithmic patterns and/or the summarization engines, potential material to be provided to the user, the potential material selected from the corpus of educational content.

FIG. 5 is a flow diagram illustrating one example of a method for personalized learning based on functional summarization. At 500, course material associated with a given topic of a collection of topics is provided to a computing device via a graphical user interface, the course material to be learned by a user. At 502, retained material associated with the given topic is identified, the retained material indicative of a portion of the course material retained by the user. At, 504, a plurality of combinations of meta-algorithmic patterns and summarization engines are applied to provide a meta-summary. At 506, a value of each combination of meta-algorithmic patterns and summarization engines is determined based on values of each differential summary and meta-summary. At 508, a combination of meta-algorithmic patterns and summarization engines is selected for deployment of a personalized learning plan, the selected combination of meta-algorithmic patterns and summarization engines having the highest assessed value.

In one example, potential material to be provided to the computing device is determined based on the deployed meta-algorithmic patterns and/or the summarization engines, the potential material selected from the corpus of educational content.

In one example, based on the deployed combination of meta-algorithmic patterns and summarization engines, a next topic of the collection of topics is identified, and the next topic is provided to the computing device.

In one example, the meta-algorithmic patterns are based on an expert feedback, sequential try, sensitivity analysis, or proof by task completion.

Examples of the disclosure provide a generalized system for personalized learning based on functional summarization. The generalized system provides a pattern-based, automatable approach to generate a personalized learning plan through individually-optimized delivery of reinforcing learning materials based on summarization that may learn and improve over time, and is not fixed on a single technology or machine learning approach. In this way, the content used to represent a larger body of educational content, suitable to a wide range of applications, may be provided in a personalized manner.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A system comprising:
a content processor to:
provide, to a computing device via a graphical user interface, course material to be learned by a user, the course material selected from a corpus of educational content, and
identify retained material indicative of a portion of the course material retained by the user;
a plurality of summarization engines, each summarization engine to provide a differential summary indicative of differences between the retained material and the corpus of educational content;
at least one meta-algorithmic pattern to be applied to at least two differential summaries to provide a meta-summary using the at least two differential summaries;
an evaluator to determine a value of each differential summary and meta-summary; and
a selector to select a meta-algorithmic pattern or a summarization engine that provides the meta-summary or differential summary, respectively, having the highest assessed value.

2. The system of claim 1, wherein the selector selects for deployment the meta-algorithmic patterns and/or the summarization engines which provide the meta-summaries and/or differential summaries, respectively, having the highest assessed values.

3. The system of claim 2, wherein the content processor further identifies, based on the deployed meta-algorithmic patterns and/or the summarization engines, potential material to be provided to the user, the potential material selected from the corpus of educational content.

4. The system of claim 3, wherein the content processor personalizes the potential material to the user.

5. The system of claim 4, wherein the content processor personalizes the potential material to minimize learning time.

6. The system of claim 4, wherein the course material includes a collection of topics from the corpus of educational content, and the content processor personalizes the potential material to generate a sequence of topics based on the collection of topics.

7. The system of claim 4, wherein the content processor personalizes the potential material to identify reinforcement material of the course material.

8. The system of claim 4, wherein the at least one meta-algorithmic pattern is based on an expert feedback, and the content processor personalizes the potential material based on a functional relation between the course material and the retained material.

9. The system of claim 1, wherein the at least one meta-algorithmic pattern is based on an expert feedback, sequential try, sensitivity analysis, or proof by task completion.

10. A method to generate a personalized learning plan based on a meta-algorithm pattern, the method comprising:
providing to a computing device via a graphical user interface, for a given topic of a collection of topics, course material associated with the given topic, the course material to be learned by a user;
identifying retained material associated with the given topic, the retained material indicative of a portion of the course material retained by the user,
applying a plurality of combinations of meta-algorithmic patterns and summarization engines, wherein:
each summarization engine provides a differential summary indicative of differences between the retained material and the corpus of educational content for the given topic, and
each meta-algorithmic pattern is applied to at least two differential summaries to provide, via the processor, a meta-summary;
determining a value of each combination of meta-algorithmic patterns and summarization engines based on values of each differential summary and meta-summary; and
selecting, for deployment of a personalized learning plan, a combination of meta-algorithmic patterns and summarization engines having the highest assessed value.

11. The method of claim 10, further comprising determining, based on the deployed meta-algorithmic patterns and/or the summarization engines, potential material to be provided to the computing device, the potential material selected from the corpus of educational content.

12. The method of claim 11, further comprising:
identifying, based on the deployed combination of meta-algorithmic patterns and summarization engines, a next topic of the collection of topics; and
providing the next topic to the computing device.

13. The method of claim 10, wherein the meta-algorithmic patterns are based on an expert feedback, sequential try, sensitivity analysis, or proof by task completion.

14. A non-transitory computer readable medium comprising executable instructions to:
provide, to a computing device via a graphical user interface, course material to be learned by a user, the course material selected from a corpus of educational content;
identify retained material indicative of a portion of the course material retained by the user;
apply a plurality of summarization engines, each summarization engine to provide a differential summary indicative of differences between the retained material and the corpus of educational content;
apply a plurality of meta-algorithmic patterns, each meta-algorithmic pattern to be applied to at least two differential summaries to provide a meta-summary using the at least two differential summaries;
determine a value of each differential summary and meta-summary;
deploy, to provide a personalized learning plan to the user, the meta-algorithmic patterns and/or the summarization engines which provide the meta-summaries and/or differential summaries, respectively, having the highest assessed values.

15. The non-transitory computer readable medium of claim 14, further comprising executable instructions to determine, based on the deployed meta-algorithmic patterns and/or the summarization engines, potential material to be provided to the user, the potential material selected from the corpus of educational content.
